(19) United States
(12) Patent Application Publication
(10) Pub. No.: US 2006/0044974 A1
(43) Pub. Date: Mar. 2, 2006

(54) Optical disc apparatus

(75) Inventors: Hiroyuki Nakamura, Chiisagata-gun (JP); Yuji Handa, Chiisagata-gun (JP)

Correspondence Address: BIRCH STEWART KOLASCH & BIRCH, PO BOX 747, FALLS CHURCH, VA, 22040-0747, US

(73) Assignee: Shinano Kenshi Kabushiki Kaisha

(21) Appl. No.: 11/199,155

(22) Filed: Aug. 9, 2005

(30) Foreign Application Priority Data
Aug. 10, 2004 (JP) 2004-233225

(51) Int. Cl. G11B 7/00; G11B 5/09

(52) U.S. Cl. 369/53.1; 369/116; 369/47.5; 369/59.1

(57) ABSTRACT

To make it possible to write data onto an optical disc with an optimal laser power even when the data is written at a different write speed to the speed during OPC, the laser power of the reflected light is measured during formation of a pit on the recording surface of the optical disc at the start of a data write, a value of the laser power of the reflected light at a time a predetermined period after a start of the formation of the pit at the start of the data write when the laser power of the reflected light has become substantially constant is set as a reference level, and during a data write in a user data area, a measuring unit is caused to continuously measure the laser power of the reflected light when pits are formed on the recording surface of the optical disc and the laser power of the laser light emitted by the laser diode onto the optical disc is controlled so that a value of the laser power of the reflected light at a time a predetermined period after the start of pit formation when the laser power has become substantially constant always matches the set reference value.

### BACKGROUND OF THE INVENTION

1. Field of the Invention

The present invention relates to an optical disc apparatus that can write data onto an optical disc.

2. Related Art

CD-R, CD-RW, DVD−R, DVD−RW, DVD+R, DVD+RW, DVD-RAM, and the like are known as examples of optical discs onto which data can be written.

Before a write operation, an optical disc apparatus that is capable of writing data onto such optical discs carries out OPC (Optimum Power Control), i.e., a data writing test in a PCA (Power Control Area) that is a test writing area located at an innermost periphery of the recording surface of the optical disc, and thereby sets the power of the laser light during the data write at a suitable value.

An OPC operation will now be described.

The optical disc apparatus first reads optical disc identification information from the optical disc. The optical disc identification information is information relating to the optical disc and shows the manufacturer name, the compatible write speeds, the type of dye used, and the like.

Optical disc identification information is recorded in advance on an optical disc by an optical disc manufacturer as data called an “ATIP” for a CD and an “ADIP” for a DVD+.

Based on the optical disc identification information read from the optical disc, the optical disc apparatus reads an initial laser power value from a data table set in advance inside the optical disc apparatus and carries out a test write in the PCA while gradually changing the power of the laser light between values centered on the initial laser power value.

The data written by the test write is read and the top-bottom asymmetry (hereinafter expressed as beta) of the waveform of the read light intensity is examined. By examining the top-bottom asymmetry, the laser power at the time when the most favorable asymmetry was achieved is set as the optimal laser power for the optical disc.

The optical disc apparatus then emits laser light for writing with the optimal laser power set by the OPC to write data onto the optical disc.

However, there are cases where the characteristics of an optical disc differ between the inner periphery and the outer periphery and/or the temperature differs between the inner periphery and the outer periphery, so that even if the optimal laser power is set by an OPC carried out in the inner periphery, as the write moves toward the outer periphery of the optical disc, the laser power deviates from the optimal value for that part of the disc.

For this reason, there are now cases where a so-called “running OPC” (hereinafter, simply “ROPC”) where light reflected from the optical disc is measured during a data write and the laser power is adjusted to a correct value based on such measurements is carried out (see for example Japanese Laid-Open Patent Publication No. H06-76288).

An ROPC operation will now be described.

During an ROPC, an optimal laser power value is set in the OPC, the laser power of the reflected light is measured while pits are being formed on the recording surface of the optical disc using the optimal laser power value, and a value of the laser power of the reflected light at a point where the pits are substantially formed and the laser power of the reflected light becomes substantially constant is detected (referred to as the “B level”: see FIG. 2). The detected B level is set as a reference value.

When an actual data write is carried out with the optimal laser power value and the B level as a reference value set by the OPC, the writing of data commences by outputting laser light at the optimal laser power value.

After this, the laser power of the reflected light during the writing of data is continuously measured and the emitted laser power is continuously controlled so that the B level of the laser power of the reflected light during the data write is kept equal to the B level obtained as the reference value by the OPC. This operation is called “ROPC”.

By carrying out this ROPC operation, it is possible to carry out data writes on the optical disc with stabilized recording quality.

When the ROPC is executed using the B level obtained by the OPC as a reference value, if the actual data write speed is higher than (i.e., a multiple of) the speed during the OPC, there is the problem that the value of the B level obtained by the OPC will no longer be the correct value, the laser power tends to be too low, and the recording quality falls.

Two examples of control methods where the actual data write speed is faster than the speed during the OPC will now be described.

A first control method is called ZCLV (Zone Constant Linear Velocity) where the recording surface of the disc is divided into a plurality of concentric zones and data is written at a constant linear velocity inside each zone. In ZCLV, control is carried out to write data at low speed in zones in the inner periphery of the optical disc and to write data at high speed in zones in the outer periphery. As the write position moves to different zones in the outer periphery of the optical disc, the speed is raised in steps, thereby making it possible to raise the overall write speed of the optical disc.

A second control method is called PCAV (Partial Constant Angular Velocity) where data is written at a constant angular velocity (CAV) in the inner periphery of the optical disc and at a constant linear velocity (CLV) in the outer periphery of the optical disc.

According to PCAV, the write performance is lowered in the inner circumference of the optical disc and high-speed writing is carried out stably in the outer periphery of the optical disc.

In this way, according to the control method for the laser power that uses conventional ROPC, in the case where the write speed changes in the outer periphery of the optical disc, even if the laser power is controlled with the B level calculated by the OPC as a reference, since the speed will change as the write moves to the outer periphery of the optical disc, the B level obtained by the OPC will deviates from the correct value, the laser power will not be controlled optimally, and the recording quality will fall.

### SUMMARY OF THE INVENTION

The present invention was conceived in view of the problem described above and it is an object of the present invention to provide an optical disc apparatus that can carry out a data write on an optical disc with an optimal laser power when a data write is carried out at a different write speed to the speed during OPC, such as when the speed differs between the inner periphery and outer periphery of the optical disc as with ZCLV or PCAV, for example.

An optical disc apparatus according to the present invention is capable of writing data onto an optical disc and includes: an optical pickup including a laser diode that emits laser light onto an optical disc that has been loaded and a photodetector that receives light reflected from the optical disc; a measuring unit for measuring laser power of the reflected light received by the photodetector; and a control unit for controlling laser power of the laser light emitted onto the optical disc by the laser diode based on the laser power of the reflected light measured by the measuring unit, wherein the control unit measures the laser power of the reflected light during formation of a pit on a recording surface of the optical disc at a start of a data write, sets, as a reference level, a value of the laser power of the reflected light at a time a predetermined period after a start of the formation of the pit at the start of the data write where the laser power of the reflected light has become substantially constant, and during a data write in a user data area, causes the measuring unit to continuously measure the laser power of the reflected light when pits are formed on the recording surface of the optical disc and controls the laser power of the laser light emitted by the laser diode onto the optical disc so that a value of the laser power of the reflected light at a time a predetermined period after the start of formation of a pit when the laser power has become substantially constant always matches the set reference value.

By using the configuration described above, instead of carrying out ROPC using a reference level set during OPC, a reference level is calculated based on reflected light for an actual data write in the user data area and the laser power is controlled based on this reference level. Accordingly, even if a data write is carried out at a higher speed than the write speed during OPC, it is possible to stably carry out a data write with a laser power more suited to present conditions. Also, even when ZCLV or PCAV is used, it is believed that data writes will be carried out with a laser power that is closer to optimal.

Another optical disc apparatus according to the present invention is capable of writing data onto an optical disc and includes: an optical pickup including a laser diode that emits laser light onto an optical disc that has been loaded and a photodetector that receives light reflected from the optical disc; a measuring unit for measuring laser power of the reflected light received by the photodetector; and a control unit for controlling laser power of the laser light emitted onto the optical disc by the laser diode based on the laser power of the reflected light measured by the measuring unit, wherein the control unit measures the laser power of the reflected light during formation of a pit on a recording surface of the optical disc at a start of a data write, sets, as a reference level, a value of the laser power of the reflected light at a time a predetermined period after a start of the formation of the pit at the start of the data write when the laser power of the reflected light has become substantially constant, and during a data write in a user data area, causes the measuring unit to continuously measure the laser power of the reflected light when pits are formed on the recording surface of the optical disc and controls the laser power of the laser light emitted by the laser diode onto the optical disc so that a value of the laser power of the reflected light at a time a predetermined period after the start of pit formation when the laser power has become substantially constant is always within a predetermined range that spans the set reference level.

By using the configuration described above, instead of carrying out ROPC using a reference level set during OPC, a reference level is calculated based on reflected light for an actual data write in the user data area and the laser power is controlled based on this reference level. Accordingly, even if a data write is carried out at a higher speed than the write speed during OPC, it is possible to stably carry out a data write with a laser power more suited to present conditions. Also, even when ZCLV or PCAV is used, it is believed that data writes will be carried out with a laser power that is closer to optimal.

Another optical disc apparatus according to the present invention is capable of writing data onto an optical disc and includes: an optical pickup including a laser diode that emits laser light onto an optical disc that has been loaded and a photodetector that receives light reflected from the optical disc; a measuring unit for measuring laser power of the reflected light received by the photodetector; and a control unit for controlling laser power of the laser light emitted onto the optical disc by the laser diode based on the laser power of the reflected light measured by the measuring unit, wherein during a data write in a user data area, the control unit causes the measuring unit to continuously measure the laser power of the reflected light when pits are formed on a recording surface of the optical disc and controls the laser power of the laser light emitted by the laser diode onto the optical disc so that a value of the laser power of the reflected light at a time a predetermined period after the start of formation of a pit when the laser power has become substantially constant is always within a predetermined range that is determined in advance for each type of optical disc.

By using the configuration described above, instead of carrying out ROPC using a reference level set during OPC, the laser power is controlled based on a predetermined range that is calculated in advance based on experiments or theory for each type of optical disc and is stored inside the optical disc apparatus. Accordingly, even if a data write is carried out at a higher speed than the write speed during OPC, it is possible to stably carry out a data write with a laser power more suited to present conditions. Also, even when ZCLV or PCAV is used, it is believed that data writes will be carried out with a laser power that is closer to optimal.

The predetermined range may be defined by an upper threshold and a lower threshold and at least one of the upper threshold and the lower threshold may be composed of a plurality of threshold values, and on determining that the value of the laser power of the reflected light at a time a predetermined period after the start of formation of a pit when the laser power has become substantially constant has matched one of the plurality of threshold values, the control unit may control the laser power of the laser light emitted by the laser diode onto the optical disc with the threshold value that has been matched to move away from the threshold value, on determining that the value of the laser power of the reflected light matches a previously matched threshold value, the control unit may subsequently not control the laser power of the laser light emitted by the laser diode onto the optical disc, and on determining that the value of the laser power of the reflected light matches a threshold value that has not been determined to have been matched previously, the control unit may control the laser power of the laser light emitted by the laser diode onto the optical disc to move away from the threshold value.

According to the above configuration, when the upper limit value and the lower limit value of the predetermined range change depending on distance in the radius direction of the optical disc, the upper limit value and the lower limit value do not need to be stored as functions, so that the time and effort required to calculate such functions in advance and a function for calculating the upper limit value and lower limit value every time using the function can be omitted.

It should be noted that with regard to “a predetermined range” in the present specification, the expressions “upper limit value” and “lower limit value” are used in the case where such values change and the expressions “upper threshold” and “lower threshold” are used when such values are fixed.

### BRIEF DESCRIPTION OF THE DRAWINGS

The aforementioned and other objects and advantages of the present invention will become apparent to those skilled in the art upon reading and understanding the following detailed description with reference to the accompanying drawings.

In the drawings:

FIG. 1 is a block diagram showing the construction of an optical disc apparatus;

FIG. 2 is a diagram useful in explaining laser power;

FIG. 3 is a flowchart useful in explaining an OPC operation in a control method for a data write;

FIG. 4 is a flowchart useful in explaining an ROPC operation in the control method for a data write;

FIG. 5 is a block diagram showing the construction of a second embodiment of an optical disc apparatus;

FIG. 6 is a diagram useful in explaining the relationship between a predetermined range stored in the data table in the second embodiment and a B level of laser power of reflected light;

FIG. 7 is a flowchart useful in explaining a control method (ROPC) for a data write according to the second embodiment;

FIG. 8 is a block diagram showing the construction of a third embodiment of an optical disc apparatus;

FIG. 9 is a diagram useful in explaining the relationship between a predetermined range stored in the data table in the third embodiment and a B level of laser power of reflected light; and

FIG. 10 is a flowchart useful in explaining a control method (ROPC) for a data write according to the third embodiment.

### DESCRIPTION OF THE PREFERRED EMBODIMENTS

In short, the basic concept behind the following preferred embodiments of the present invention is that when ROPC control is carried out by an optical disc apparatus, instead of controlling the laser power during a data write with the B level obtained during OPC as a reference B level, the laser power during a data write is controlled with a B level obtained when an actual data write commences in the user data area as a reference B level.

### First Embodiment

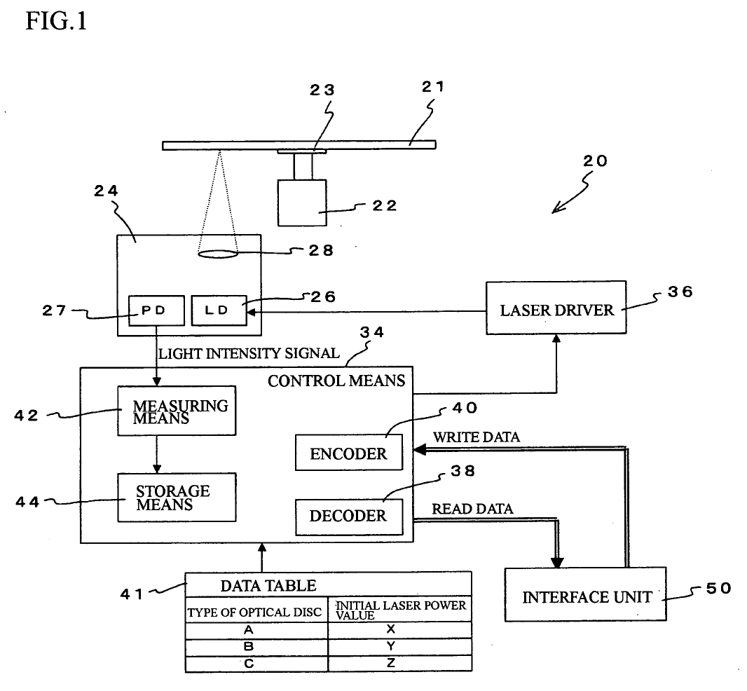

The construction of an optical disc apparatus according to the present invention will now be described with reference to FIG. 1.

An optical disc apparatus 20 includes a spindle motor 22, on which a turntable 23 for mounting an optical disc 21 is provided, and an optical pickup 24 that emits laser light on the optical disc 21 and receives laser light reflected from the optical disc 21.

The optical pickup 24 includes a laser diode (LD) 26 that outputs laser light and a photodetector (PD) 27 that is a light-receiving element. An objective lens 28 that collimates the laser light and focuses the laser light on the recording surface of the optical disc is provided inside the optical pickup 24.

In the photodetector 27, light intensity at the light receiving surface is converted to a voltage value that is inputted into a control means 34 provided outside the optical pickup 24.

The laser power of the laser light outputted by the laser diode 26 inside the optical pickup 24 can be adjusted by a laser driver 36 controlling the driving current of a laser diode 26.

When data is written onto the optical disc 21, the laser diode 26 emits laser light of a high-output laser power and a low-output laser power toward the optical disc 21 in accordance with binary data expressing the data to be written. When the high-output laser power is incident on the recording surface of the optical disc 21, a dye layer of the optical disc 21 is altered to form a “pit”. When the low-output laser power is incident on the recording surface of the optical disc 21, a dye layer of the optical disc 21 is not altered and such part becomes a “land”. In this way, pits and lands are alternately formed on the optical disc 21.

In more detail, the control means 34 is composed of a CPU that operates based on a control program stored in advance, a ROM, a RAM, and the like.

The functions of the control means 34 will now be described.

The control means 34 carries out overall control over the entire optical disc apparatus 20 based on the control program by outputting control signals to the various components.

In particular, during an ROPC operation, the control means 34 of the present embodiment carries out an operation that sets a B level of laser power of reflected light at the start of a data write as a reference B level and controls the laser power of the laser light used for writing so that during the rest of the data write, the B level of the laser power of the reflected light matches the reference B level. That is, the control means 34 has a function as a measuring means 42 that measures the laser power of the reflected light from a light intensity signal and a storage means 44 that stores the result of the measurement (more specifically, the value of the B level of the laser power of the reflected light).

The control means 34 functions as an RF amplifier (not shown) that converts data read from the optical disc 21 by the optical pickup 24 to binary and amplifies the data and as a decoder 38 that carries out EFM demodulation on the RF signal obtained by the RF amplifier function. After being decoded and converted to reproducible data, the data is transferred via an interface unit 50 to an external appliance such as a host computer (not shown).

Data to be written that has been inputted and various commands instructing the optical disc apparatus 20 to carry out operations are also inputted into the control means 34 via the interface unit 50 from an external appliance such as a host computer. A function as an encoder 40 is provided inside the control means 34 and the inputted data to be written is subjected to an encoding process such as EFM conversion and outputted to the laser driver 36.

The control means 34 also interprets the various commands inputted into the control means 34. The control means 34 then outputs control signals to the various components inside the optical disc apparatus 20 so that operations are carried out in accordance with the commands.

It should be noted that the control means 34 is connected to a data table 41 in which the initial laser power value used when carrying out OPC is set in advance for respective pieces of identification information, such as types of optical discs. In more detail, the data table 41 is composed of a memory such as a ROM.

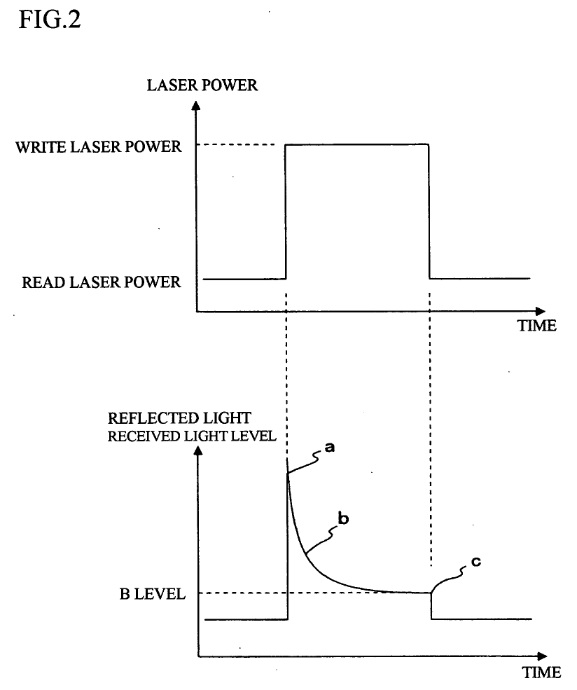

The form of the reflected light during a data write on the optical disc and the B level will now be described with reference to FIG. 2.

In the graph in the upper part of FIG. 2, the horizontal axis represents time and the vertical axis represents the magnitude of the laser power incident on the optical disc 21. The graph shown in the lower part of FIG. 2 shows the received light level for the reflected light (return light) when the laser light shown in the upper graph is incident on the optical disc 21.

When laser light with the write laser power, whose output is higher than the read laser power, is incident on the optical disc 21, substantially 100% of the write laser power returns at the start of emission (point a in FIG. 2). This is because a pit is yet to be formed at the start of emission.

Next, as a pit is formed on the recording surface, the laser power of the reflected light gradually falls (in the manner resembling a quadratic curve) (point b). Next, after the emission of the write laser power ends (point c), if laser light is emitted at the read laser power, the laser power of the reflected light will be substantially equal to the read laser power.

Here, the “B level” refers to the value of the laser power of the reflected light when laser light has been emitted at the write laser power, the formation of a pit is substantially complete, and the laser power of the reflected light has become substantially constant.

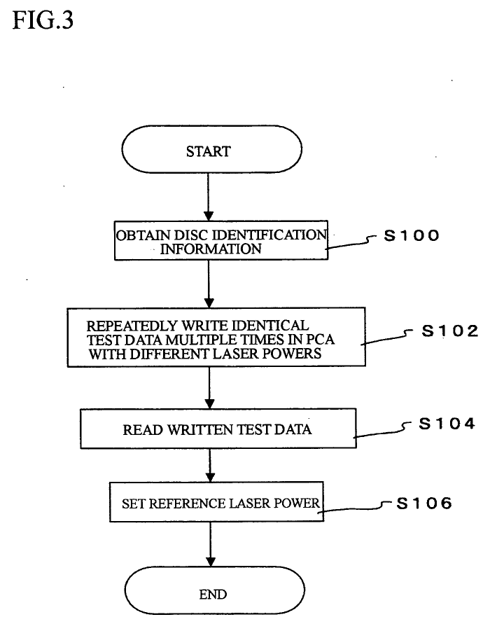

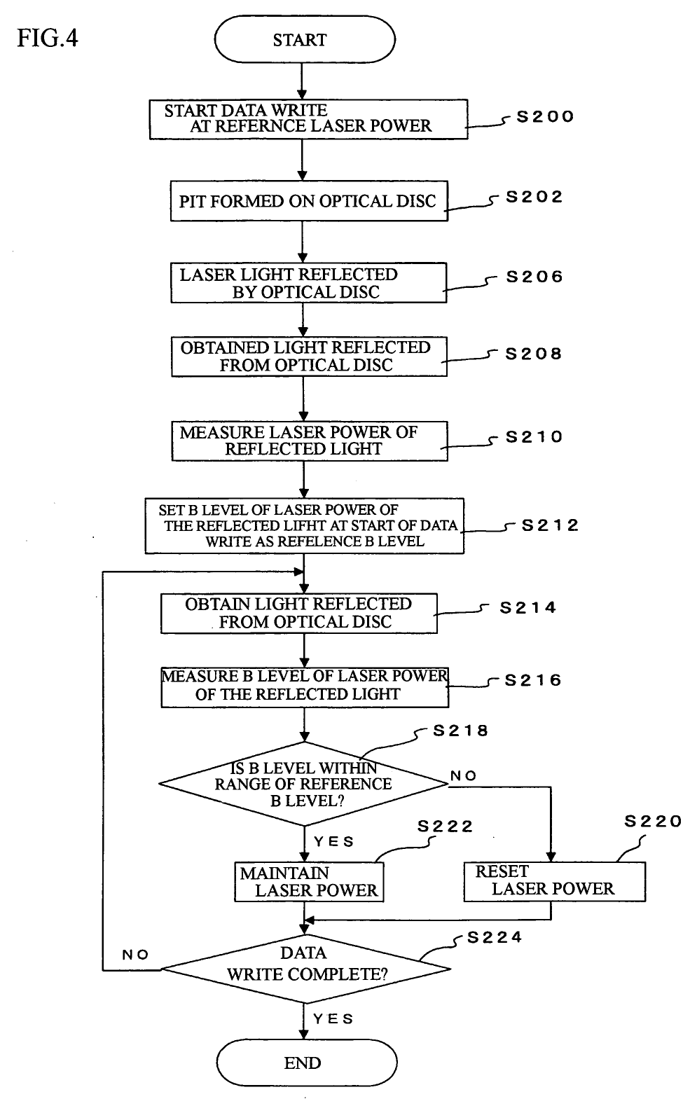

Next, the control method for a data write according to the present embodiment will be described with reference to FIGS. 3 and 4.

First, an OPC operation will be described with reference to FIG. 3.

When the optical disc 21 is loaded into the optical disc apparatus 20, the control means 34 obtains the disc identification information from the optical disc 21 itself (from the ATIP, ADIP, etc.) (step S100).

The control means 34 reads the initial laser power value from the data table 41 set in advance for each type of optical disc 21 and then attempts to write the same test data a plurality of times in the PCA while gradually changing the laser power about the initial laser power value (step S102).

Next, the control means 34 reads all of the written test data (step S104).

Next, the control means 34 stores the write laser power for data with the most favorable recording quality (data whose beta is close to the intended beta (top-bottom asymmetry) set in advance) in the storage means 44 as the reference laser power (step S106).

At this point, the OPC operation is completed.

Next, the operation (ROPC operation) during an actual data write will be described with reference to FIG. 4.

The control means 34 reads the reference laser power found by the OPC from the storage means 44 and starts to write data in the user data area with the write laser power set at the reference laser power (step S200).

By doing so, laser light of the write laser power is emitted onto the recording surface of the optical disc 21 to form a pit (step S202). At substantially the same time as step S202, the write laser light is reflected from the recording surface of the optical disc 21 (step S206).

The reflected light is received by the photodetector 27 inside the optical pickup 24 (step S208).

The measuring means 42 of the control means 34 measures the laser power of the reflected light received by the photodetector 27 as a voltage value (step S210).

Next, the control means 34 stores the B level (see FIG. 2) of the laser power of the reflected light in multiple sections (that differ depending on the disc type) at the start of a data write in the storage means 44 as the reference B level (step S212).

While continuing with the data write, the control means 34 obtains reflected light in the same way as the combination of step S202, step S206, and step 208 (step S214).

Next, the control means 34 measures the B level from the laser power of the reflected light during the data write (step S216).

The control means 34 compares the B level measured in step S216 and the reference B level stored inside the storage means 44. More specifically, a range composed of an upper limit and a lower limit centered on the reference B level is provided and it is determined whether the B level measured in step S216 is within this range (step S218).

If the B level measured in step S216 is outside the range of the reference B level, the control means 34 controls the laser driver 36 to change the laser power so that the B level during the present data write approaches the reference B level. More specifically, the laser power is changed by carrying out an operation that adds or subtracts a predetermined amount of power that is set in advance (step S220).

If the B level measured in step S216 is within the range of the reference B level, the control means 34 keeps the laser power during the present data write at the present level (step S222).

The control means 34 repeatedly carries out steps S214 to S222 until the data write is completed (step S224).

It should be noted that in the present embodiment described above, the control means determines whether the measured B level is within the range of the reference B level. However, the present invention is not limited to this configuration and it is possible to determine whether the measured B level matches the reference B level and maintain the present laser power of the write laser light if the measured B level matches the reference B level or carry out control to change the laser power so that the B level of the present data write matches the reference B level.

### Second Embodiment

A second embodiment of an optical disc apparatus according to the present invention will now be described. FIG. 5 shows the internal construction of the second embodiment.

It should be noted that component elements that are the same as in the first embodiment described above have been assigned the same reference numerals in the drawings and description thereof has been omitted.

The control means 34 of the present embodiment carries out an operation that controls the laser power of the writing laser light so that during the ROPC operation, the B level of the laser power of the reflected light during a data write is within a predetermined range set in advance. That is, the control means 34 has a function as a measuring means 42 that measures the laser power of the reflected light from the light intensity signal and a function as a storage means 44 that stores the result of such measurement (more specifically the value of the B level of the laser power of the reflected light).

It should be noted that in addition to the data table 41 in which an initial laser power value used during execution of OPC is set in advance for each piece of identification information such as an optical disc type, the control means 34 is connected to a data table 46 in which a predetermined range for the B level of the laser power of the reflected light mentioned above is set in advance for each piece of identification information such as an optical disc type.

In more detail, the data table 41 and the data table 46 are constructed of memories such as ROMs.

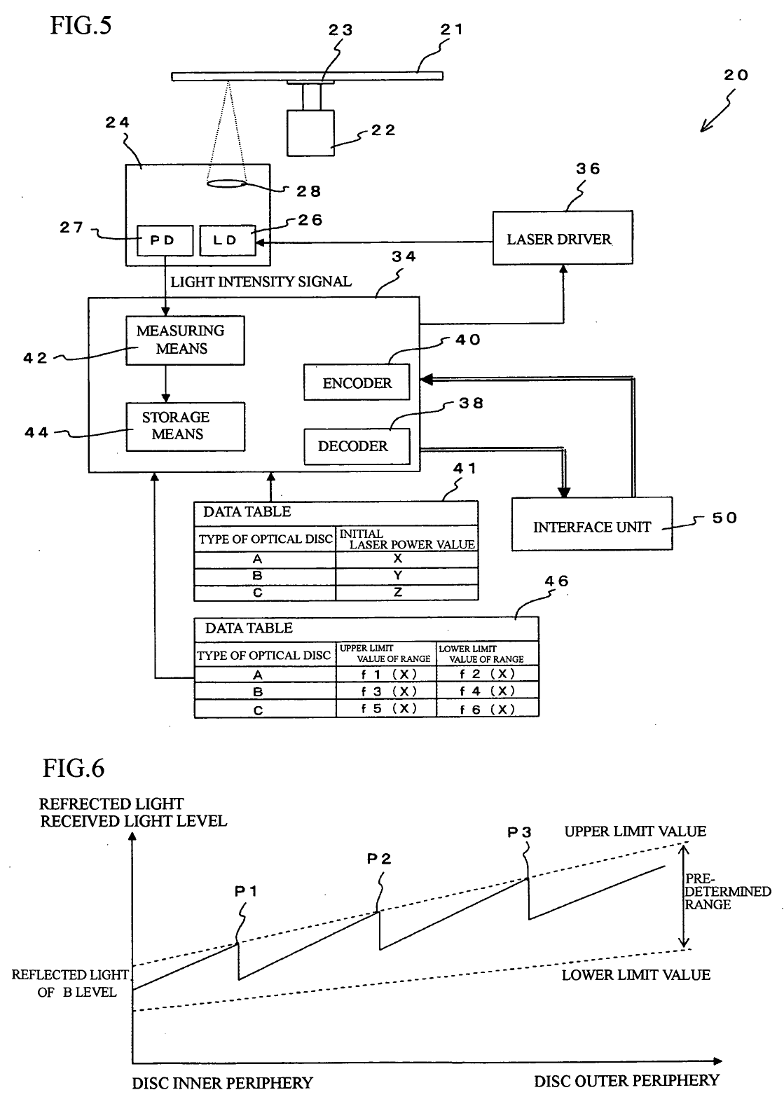

The relationship between the predetermined range stored in the data table 46 and the B level of the laser power of the reflected light is shown in FIG. 6.

The control means 34 controls the laser power of the laser light so that the B level of the laser power of the reflected light during a write is always in a predetermined range defined by an upper limit value and a lower limit value.

As shown in FIG. 6, the predetermined range differs for different positions in the radial direction of the optical disc. In the present embodiment, the predetermined range itself gradually rises (i.e., the upper limit value and the lower limit value both rise) toward the outer periphery of the optical disc. In addition, the width of the range (the difference between the upper limit value and the lower limit value) gradually widens toward the outer periphery of the optical disc. However, depending on the type of optical disc, the predetermined range itself may gradually fall (i.e., the upper limit value and the lower limit value both fall) toward the outer periphery of the optical disc and the width of the range (the difference between the upper limit value and the lower limit value) does not need to gradually widen toward the outer periphery of the optical disc.

The predetermined range stored in the data table 46 is stored with the upper limit value and lower limit value of the range for each type of optical disc as predetermined functions (f1(x) to f6(x) in FIG. 5). As shown in FIG. 6, the predetermined functions express y as a function of x where the horizontal axis (x axis) represents a position in the radial direction of the optical disc and the vertical axis (y axis) represents the value of the B level of the laser power of the reflected light. For example, in the case where the upper limit value and the lower limit value increase linearly toward the outer periphery of the optical disc, the upper limit value and the lower limit value are respectively linear functions of x.

Accordingly, if the present write position of the optical pickup is known, the upper limit value and the lower limit value of the predetermined range at that position can be calculated from the predetermined functions.

The overall operation of the control means 34 will now be described.

As shown in FIG. 6, in the case where the control means 34 has determined that the B level of the laser power of the reflected light has gradually risen within the predetermined range to become equal to the upper limit value (the point PI), for example, the control means 34 controls the laser driver 36 so that the B level of the laser power of the reflected light falls by a predetermined amount, or in other words raises the laser power emitted by the LD 26 to lower the B level.

After this, in the case where the control means 34 has determined that the B level of the laser power of the reflected light has gradually risen within the predetermined range to again become equal to the upper limit value (points P2 and P3), the control means 34 controls the laser driver 36 so that the B level of the laser power of the reflected light falls by a predetermined amount, or in other words raises the laser power emitted by the LD 26 to lower the B level.

Conversely, in the case where the control means 34 has determined that the B level of the laser power of the reflected light has become equal to the lower limit value of the predetermined range, the control means 34 controls the laser driver 36 so that the B level of the laser power of the reflected light rises by a predetermined amount, or in other words lowers the laser power emitted by the LD 26 to raise the B level.

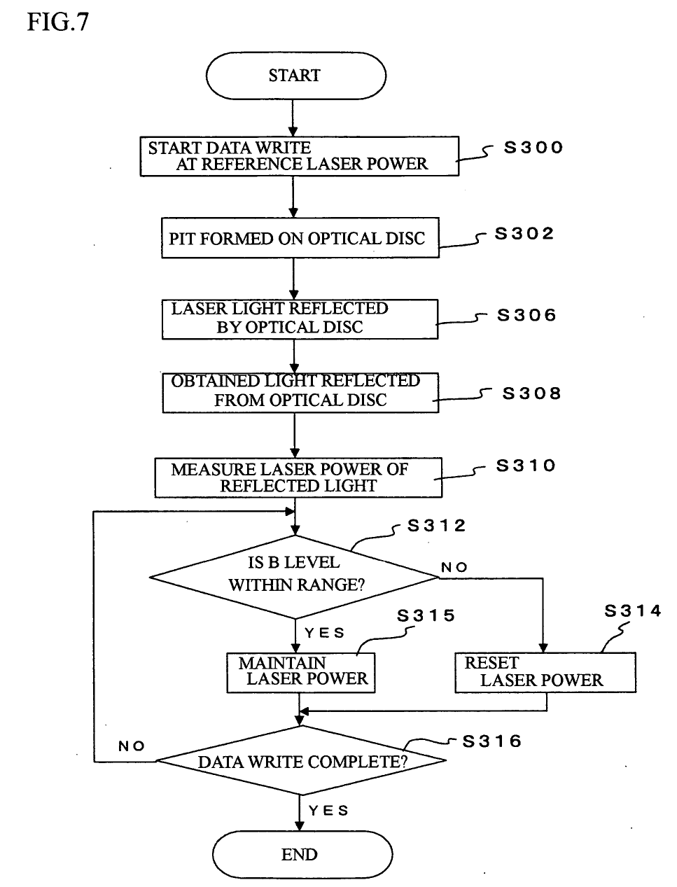

Next, the control method for a data write in the present embodiment will be described with reference to FIG. 7.

Since the OPC operation is the same as in the first embodiment described above, only the ROPC operation will be described below.

The control means 34 reads the reference laser power found by the OPC from the storage means 44 and starts to write data in the user data area with the write laser power set at the read reference laser power (step S300).

By doing so, laser light of the write laser power is emitted onto the recording surface of the optical disc 21 to form a pit (step S302). At substantially the same time as step S302, the write laser light is reflected from the recording surface of the optical disc 21 (step S306).

The reflected light is received by the photodetector 27 inside the optical pickup 24 (step S308).

The measuring means 42 of the control means 34 measures the B level of the laser power of the reflected light received by the photodetector 27 as a voltage value (step S310).

Next, the control means 34 compares the B level obtained in step S310 with the upper limit value and the lower limit value of the predetermined range stored in advance in the data table 46 (step S312).

When the B level measured in step S310 is outside the predetermined range (when the B level matches the upper limit value or the lower limit value as shown in FIG. 6), the control means 34 has the laser driver 36 carry out control to change the laser power so that the B level during the data write is within the predetermined range. More specifically, the laser power is changed by an operation that adds or subtracts a predetermined amount of power that is set in advance (step S314).

When the B level set in step S310 is within the range of the reference B level, the control means 34 keeps the laser power of the write laser light at the present value (step S315).

The control means 34 repeatedly executes steps S312 to S314 until the data write is complete (step S316).

### Third Embodiment

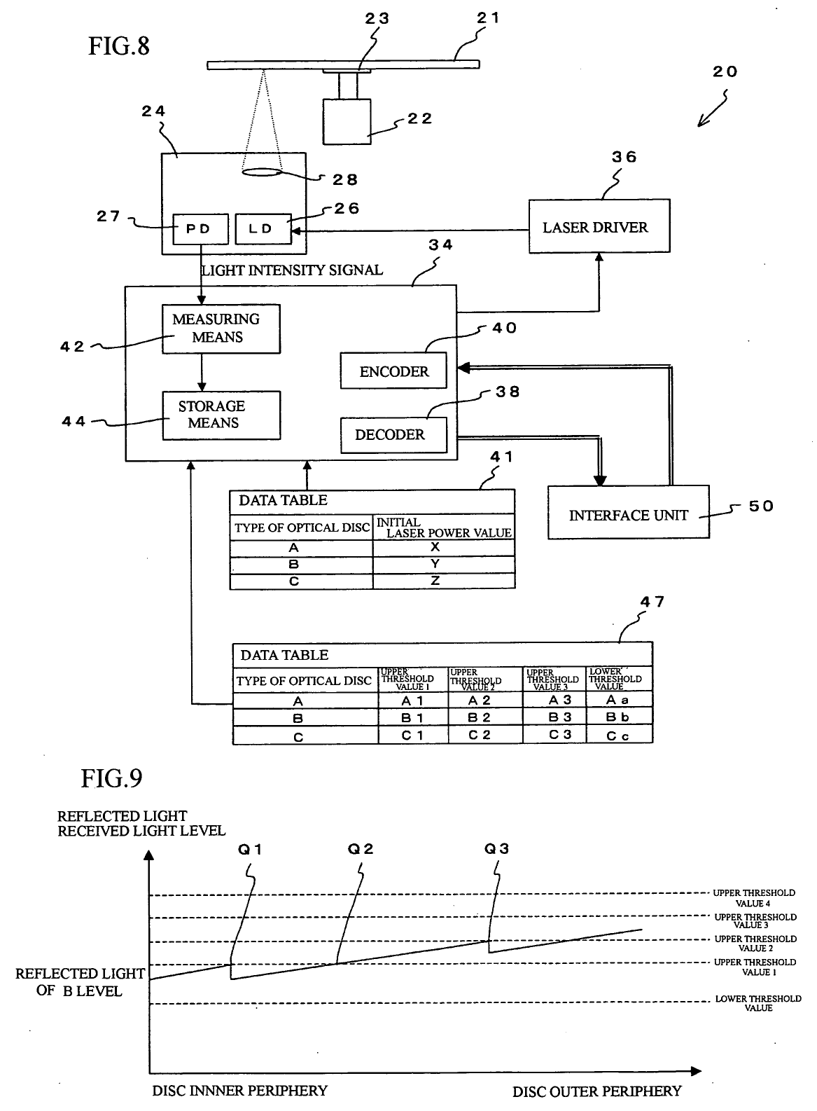

Next, a third embodiment of an optical disc apparatus according to the present invention will be described. The internal construction of the third embodiment is shown in FIG. 8.

It should be noted that component elements that are the same as in the first and second embodiments described above have been assigned the same reference numerals in the drawings and description thereof has been omitted.

The control means 34 of the present embodiment carries out an operation that controls the laser power of the writing laser light so that during the ROPC operation, the B level of the laser power of the reflected light during a data write is within a predetermined range set in advance. That is, the control means 34 has a function as a measuring means 42 that measures the laser power of the reflected light from the light intensity signal and a function as a storage means 44 that stores the result of such measurement (more specifically the value of the B level of the laser power of the reflected light).

It should be noted that in addition to the data table 41 in which an initial laser power value used during execution of OPC is set in advance for each piece of identification information such as an optical disc type, the control means 34 is connected to a data table 47 in which a predetermined range for the B level of the laser power of the reflected light mentioned above is set in advance for each piece of identification information such as an optical disc type.

It should be noted that a “predetermined range” referred to in the present embodiment is defined by an upper threshold and a lower threshold, with the upper threshold and/or the lower threshold being a plurality of threshold values of different values. Here, an example where only the upper threshold has a plurality of levels and the lower threshold has a single value will be described. Accordingly, a plurality of upper threshold values and a single lower threshold value are stored in advance in the data table 47 for each type of optical disc.

In more detail, the data table 41 and the data table 47 are constructed of memories such as ROMs.

Although the present embodiment is the same as the second embodiment in carrying out control so that the value of the B level of the reflected light is within the predetermined range, the method of setting the range differs.

That is, as shown in FIG. 9, in the present embodiment, a plurality of levels (threshold value 1 to threshold value 4) for the threshold value for the B level of the laser power of the reflected light are set in advance for each type of optical disc. When the value of the B level of the laser power of the reflected light during a data write matches the threshold value 1 with the lowest value out of the plurality of threshold levels (Q1), the control means 34 controls the laser driver 36 so that the B level falls by a predetermined amount, or in other words raises the laser power emitted by the LD 26 to lower the B level.

Next, the B level of the laser power of the reflected light gradually rises, and even if the value rises to the threshold value 1 that was previously matched, control is not carried out to lower the B level (Q2) and instead when the B level matches the second lowest threshold value (Q3), the control means 34 controls the laser driver 36 so that the B level falls by a predetermined amount, or in other words raises the laser power emitted by the LD 26 to lower the B level.

That is, the control means 34 of the present embodiment has a plurality of threshold values and does not carry out control to lower the B level of the laser power of the reflected light if the B level matches one of the threshold values that the B level has matched previously, and only controls the laser driver 36 when the B level of the laser power of the reflected light matches a threshold value that has not been matched previously.

In this way, the upper threshold and/or the lower threshold is provided with a plurality of threshold values, and even if the value of the B level matches the same threshold value again, the value of the B level is not controlled so as to fall. This means that the value of the B level of the laser power of the reflected light is allowed to gradually rise (or fall) toward the outer periphery of the disc. In the second embodiment the upper limit value and the lower limit value of the range need to be calculated as functions so that the upper limit value and the lower limit value can gradually rise or fall, but in this third embodiment, there is no need to calculate functions and store such functions in advance, and the value of the B level can be controlled so as to rise or fall by merely storing a plurality of threshold values in advance.

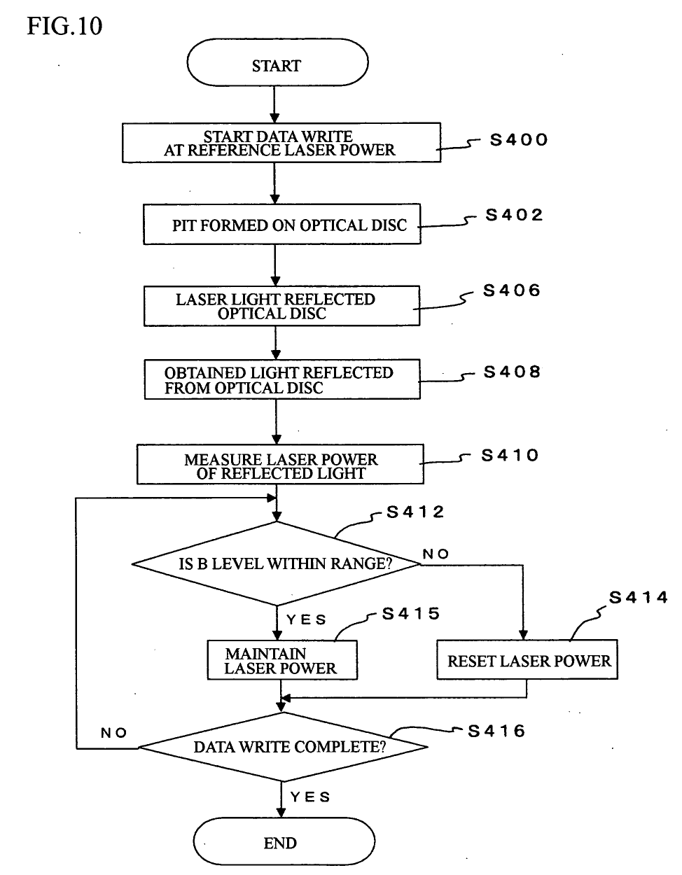

Next, the method of controlling a data write in the present embodiment will be described with reference to FIG. 10.

Since the OPC operation is the same as in the first embodiment described above, only the ROPC operation will be described below.

The control means 34 reads the reference laser power found by the OPC from the storage means 44 and starts a data write in the user data area with the write laser power set at the read reference laser power (step S400).

By doing so, laser light of the write laser power is emitted onto the recording surface of the optical disc 21 to form a pit (step S402). At substantially the same time as step S402, the write laser light is reflected from the recording surface 21 (step S406).

The photodetector 27 inside the optical pickup 24 receives the reflected light (step S408).

The measuring means 42 of the control means 34 measures the B level of the laser power of the reflected light received by the photodetector 27 as a voltage value (step S410).

Next, the control means 34 compares the B level obtained in step S410 with the upper threshold and the lower threshold of the predetermined range stored in advance in the data table 46 (step S412). Here, at least one of the upper threshold and the lower threshold is composed of a plurality of threshold values, and the control means 34 compares the value of the B level with threshold values out of the plurality of threshold values in the upper threshold and lower threshold that have not been matched so far. That is, as described above, the value of the B level is not compared with threshold values that the value of the B level has already matched once.

When the B level measured in step S410 is outside the predetermined range (when the B level matches the upper limit value or the lower limit value as shown in FIG. 9), the control means 34 has the laser driver 36 carry out control to change the laser power so that the B level during the data write is within the predetermined range. More specifically, the laser power is changed by an operation that adds or subtracts a predetermined amount of power that is set in advance (step S414).

When the B level set in step S410 is within the range of the reference B level, the control means 34 keeps the laser power of the write laser light at the present value (step S415).

The control means 34 repeatedly executes steps S412 to S414 until the data write is complete (step S416).

Although an example where only the upper threshold has a plurality of threshold values has been described in the third embodiment, only the lower threshold may have a plurality of threshold values, or both the upper and lower thresholds may have a plurality of threshold values.

The present invention is not limited to the various preferred embodiments that are described above and can obviously be subjected to a variety of modifications without departing from the scope of the invention.

What is claimed is:

1. An optical disc apparatus capable of writing data onto an optical disc, comprising:
an optical pickup including a laser diode that emits laser light onto an optical disc that has been loaded and a photodetector that receives light reflected from the optical disc;
measuring means for measuring laser power of the reflected light received by the photodetector; and
control means for controlling laser power of the laser light emitted onto the optical disc by the laser diode based on the laser power of the reflected light measured by the measuring means,
wherein the control means
measures the laser power of the reflected light during formation of a pit on a recording surface of the optical disc at a start of a data write,
sets, as a reference level, a value of the laser power of the reflected light at a time a predetermined period after a start of the formation of the pit at the start of the data write where the laser power of the reflected light has become substantially constant, and
during a data write in a user data area, causes the measuring means to continuously measure the laser power of the reflected light when pits are formed on the recording surface of the optical disc and controls the laser power of the laser light emitted by the laser diode onto the optical disc so that a value of the laser power of the reflected light at a time a predetermined period after the start of formation of a pit when the laser power has become substantially constant always matches the set reference value.

2. An optical disc apparatus capable of writing data onto an optical disc, comprising:
an optical pickup including a laser diode that emits laser light onto an optical disc that has been loaded and a photodetector that receives light reflected from the optical disc;
measuring means for measuring laser power of the reflected light received by the photodetector; and
control means for controlling laser power of the laser light emitted onto the optical disc by the laser diode based on the laser power of the reflected light measured by the measuring means,
wherein the control means
measures the laser power of the reflected light during formation of a pit on a recording surface of the optical disc at a start of a data write,
sets, as a reference level, a value of the laser power of the reflected light at a time a predetermined period after a start of the formation of the pit at the start of the data write when the laser power of the reflected light has become substantially constant, and
during a data write in a user data area, causes the measuring means to continuously measure the laser power of the reflected light when pits are formed on the recording surface of the optical disc and controls the laser power of the laser light emitted by the laser diode onto the optical disc so that a value of the laser power of the reflected light at a time a predetermined period after the start of pit formation when the laser power has become substantially constant is always within a predetermined range that spans the set reference level.

3. An optical disc apparatus capable of writing data onto an optical disc, comprising:
an optical pickup including a laser diode that emits laser light onto an optical disc that has been loaded and a photodetector that receives light reflected from the optical disc;
measuring means for measuring laser power of the reflected light received by the photodetector; and
control means for controlling laser power of the laser light emitted onto the optical disc by the laser diode based on the laser power of the reflected light measured by the measuring means,
wherein during a data write in a user data area, the control means causes the measuring means to continuously measure the laser power of the reflected light when pits are formed on a recording surface of the optical disc and controls the laser power of the laser light emitted by the laser diode onto the optical disc so that a value of the laser power of the reflected light at a time a predetermined period after the start of formation of a pit when the laser power has become substantially constant is always within a predetermined range that is determined in advance for each type of optical disc.

4. An optical disc apparatus according to claim 3,
wherein the predetermined range is defined by an upper threshold and a lower threshold and at least one of the upper threshold and the lower threshold is composed of a plurality of threshold values, and
on determining that the value of the laser power of the reflected light at a time a predetermined period after the start of formation of a pit when the laser power has become substantially constant has matched one of the plurality of threshold values, the control means controls the laser power of the laser light emitted by the laser diode onto the optical disc with the threshold value that has been matched to move away from the threshold value,
on thereafter determining that the value of the laser power of the reflected light matches a previously matched threshold value, the control means does not control the laser power of the laser light emitted by the laser diode onto the optical disc, and
on determining that the value of the laser power of the reflected light matches a threshold value that has not been determined to have been matched previously, the control means controls the laser power of the laser light emitted by the laser diode onto the optical disc to move away from the threshold value.
